(19) United States
(12) Patent Application Publication
(10) Pub. No.: US 2013/0307263 A1
(43) Pub. Date: Nov. 21, 2013

(54) Quick Connector

(71) Applicants: Brian Parks, Howell, MI (US); Matthew Lutzke, Clarkston, MI (US)

(72) Inventors: Brian Parks, Howell, MI (US); Matthew Lutzke, Clarkston, MI (US)

(21) Appl. No.: 13/982,549

(22) PCT Filed: Feb. 7, 2012
(86) PCT No.: PCT/US12/24130

§ 371 Date: Aug. 7, 2013

Related U.S. Application Data
(60) Provisional application No. 61/442,057, filed on Feb. 11, 2011.

(51) Int. Cl. F16L 37/02

(52) U.S. Cl. CPC F16L 37/02
USPC 285/319

(57) ABSTRACT

A quick connector assembly for quickly connecting and establishing fluid communication between a male end form having a bead and a hose or any other type of tube. The quick connector assembly includes a housing having a stem portion for receiving the hose and a female receiving portion for receiving the male end form. A plunger is disposed within the housing, and the plunger is biased in a first direction by a spring. The quick connector further includes a locker which is held in a non-engaged position until the male end form has been inserted into the housing until the bead moves the plunger in a second direction opposite of the first direction. Once the bead of the male end form clears the locker, the locker can be moved into an engaged position with the bead of the male end form being trapped between the locker and the plunger.

### CROSS-REFERENCE TO PRIOR APPLICATION

This PCT patent application claims the benefit of U.S. Provisional Patent Application Ser. No. 61/442,057 filed Feb. 11, 2011, entitled “Quick Connector,” the entire disclosure of the application being considered part of the disclosure of this application and hereby incorporated by reference.

### BACKGROUND OF THE INVENTION

1. Field of the Invention

The present invention relates to quick connector assemblies, and more specifically, to quick connector assemblies which receive and lock with a male end form.

2. Description of the Prior Art

Quick connector assemblies are used in many different applications for quickly connecting and establishing fluid communication between a male end form and a hose or another tube. It is important that the male end form can quickly engage with the quick connector assembly to minimize assembly time and labor, e.g. on an assembly line. At the same time, the quick connector assembly must be very reliable and must establish a fluid-tight seal with the male end form which will not leak or otherwise disengage from the male end form. In the automotive industry, quick connector assemblies are often used for fuel lines, and failure of the quick connector assembly could pose a serious safety risk. To mitigate this risk, manufacturers have developed assemblies that cannot be latched down until the male end form is completely inserted into the quick connector.

One known type of quick connector assembly includes a housing having a female receiving portion for receiving a male end form and a stem portion for receiving a hose. A locker is movable between a non-engaged position for allowing insertion or withdrawal of the male end form and an engaged position for engaging the bead to retain the male end form in the housing. The locker includes a ring that prevents the locker from moving to the engaged position until the male end form is inserted into the housing by a predetermined distance, whereupon the ring breaks to allow the male end form to be fully inserted into the housing. Once the male end form is fully inserted into the housing and the bead passes the locker, the locker may be moved downwardly into the engaged position to engage the bead and hold the male end form in a locked position within the housing. The locker may then be moved back to the non-engaged position for allowing withdrawal of the male end form. However, once the male end form is removed from the quick connector assembly, because the ring has been broken, there is nothing to prevent the locker from moving back into the engaged position, even when the male end form is not disposed in the housing. Thus, this type of quick connector assembly only prevents the locker from moving to the engaged position until the quick connector assembly first receives a male end form. Thereafter, there is no safety mechanism for preventing the locker from moving to the engaged position, even when the male end form is not inserted into the housing of the quick connector assembly. A user could accidentally move the locker to the engaged position without the male end form being properly locked within the housing.

There remains a significant and continuing need for an improved quick connector assembly which is both reliable and reusable.

### SUMMARY OF THE INVENTION

One aspect of the present invention provides for a quick connector assembly including a plunger which is slidably disposed in a housing and is biased in a first direction by a spring. A locker is restricted to a non-engaged position until the male end form has been inserted into the housing by a predetermined distance, whereupon the plunger is moved in a second direction opposite of the first direction. Once the male end form has been inserted a sufficient distance into the housing, the locker can be moved into the engaged position, thereby locking the male end form with the quick connector assembly. This aspect of the present invention is advantageous because the male end form can only be correctly locked and sealed to the quick connector assembly, and the male end form can be removed and re-installed in the quick connector assembly with no loss in functionality of the quick connector assembly. Thus, movement of the locker into the engaged position provides a visual indication that the male end form is properly locked and sealed with the quick connector assembly. This aspect of the invention is also advantageous because the plunger remains biased against the bead of the male end form when the male end form is locked with the quick connector, thereby restricting movement of the male end form relative to the housing, even if the quick connector assembly is shaken, e.g. while a vehicle is travelling down a bumpy road. Even further, this aspect of the invention is advantageous because it allows the quick connector assemblies to mate with low profile male end forms, i.e. male end forms having a short distance between the bead and the tangent of a bend or a surface that deviates from the male end form's outer tube diameter.

According to another aspect of the invention, the locker includes a pair of inside legs which extend through lower gaps in the housing and provide an additional visual indication that the male end form is properly locked with the quick connector assembly. This is another safety feature of the quick connector assembly.

According to yet another aspect of the invention, the locker includes a pair of outside legs, each of which has a first arc-shaped section for contacting the housing when the locker is in the engaged position and a second arc-shaped section for contacting the housing when the locker is in the non-engaged position. This is yet another safety feature of the quick connector assembly, because the outside legs only allow the locker to move between these two positions, i.e. it cannot be in a partially-engaged position, and the outside legs also ensure that only a deliberate action by a user can move the locker from the engaged position to the non-engaged position.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a cross-sectional view of the exemplary embodiment of the quick connector assembly with the locker being in a non-engaged position;

FIG. 2 is a cross-sectional view of the exemplary embodiment of the quick connector assembly with the locker being in an engaged position;

FIG. 3 is a perspective and fragmentary view of the exemplary embodiment of the quick connector assembly with the locker being in the non-engaged position;

FIG. 4 is a perspective and fragmentary view of the exemplary embodiment of the quick connector assembly with the locker being in the engaged position; and

FIG. 5 is a flow chart depicting an exemplary method of connecting a male end form to a quick connector assembly.

### DETAILED DESCRIPTION OF THE ENABLING EMBODIMENTS

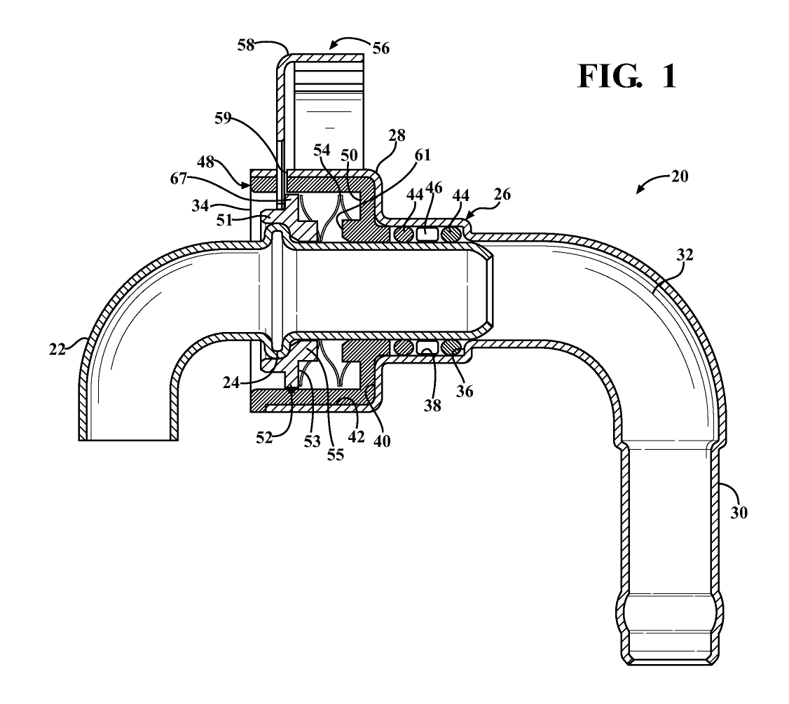

Referring to the Figures, wherein like numerals indicate corresponding parts throughout the several views, a quick connector assembly 20 for establishing fluid communication between a male end form 22 and another hose or tube (not shown) is generally shown in FIGS. 1-4. The male end form 22 is preferably of metal, has a generally tubular shape and extends to a tube end. The male end form 22 also includes a bead 24, or an annular ridge, spaced a predetermined distance from the tube end.

The quick connector assembly 20 includes a housing 26, generally indicated, presenting a female receiving portion 28 for receiving the male end form 22 and a stem portion 30 for receiving and establishing fluid communication with a hose or any other tube (not shown). In the exemplary embodiment, the housing 26 is formed of metal which is shaped through a deep drawing process. However, it should be appreciated that any other formable material may be used in place of metal (including, for example, polymeric materials or ceramics), and the housing 26 may be shaped through any desired forming process.

The housing 26 defines a bore 32 extending between the female receiving portion 28 and the stem portion 30 for conveying a fluid between the male end form 22 and the hose (not shown). The female receiving portion 28 extends along an axis and presents an inlet orifice 34 for receiving the male end form 22. The bore 32 of the female receiving portion 28 is twice-counterbored to present a first shoulder 36 opening up to a first section 38 and a second shoulder 40 opening up to a larger second section 42. Thus, the first section 38 extends between the first and second shoulders 36, 40 and has a first diameter, and the second section 42 extends between the second shoulder 40 and the inlet orifice 34 and has a second diameter which is larger than the first diameter.

A pair of sealing rings 44 is disposed in the first section 38 of the bore 32 with one of the sealing rings 44 abutting the first shoulder 36, and a spacer 46 is sandwiched in the first section 38 between the sealing rings 44. The sealing rings 44 are preferably O-rings which could be made of a variety of materials depending on the fluid and temperature requirements of the quick-connector assembly 20. The spacer 46 of the exemplary embodiment is of a thermoplastic material and is produced through an injection molding process. However, the spacer 46 can be of any other material and may be produced using any desirable forming method. It should also be appreciated that the first section 38 could alternately include any number (including zero) of sealing rings 44.

The quick connector assembly 20 of the exemplary embodiment further includes a generally cylindrical bushing 48 disposed in the second section 42 of the bore 32 and extending between the second shoulder 40 and the inlet orifice 34. The bushing 48 also extends radially inwardly along the second shoulder 40 of the housing 26 to present a first spring seat 50 (discussed in further detail below) and axially into the first section 38 to abut the first sealing ring 44 for retaining the first and second sealing rings 44 and the spacer 46 in the first section 38 of the bore 32. The bushing 48 of the exemplary embodiment is of a thermoplastic material and is produced through an injection molding process. However, the bushing 48 could alternately be of any other material and may be produced using any desirable forming process.

The quick connector assembly 20 also includes a plunger 52 having a generally annular shape which is slidably disposed within the bushing 48 in the second section 42 of the bore 32. The plunger 52 has a front section 51 with a large diameter for receiving the bead of the male end form 22 and a rear section 55 having a smaller diameter for receiving the portion of the male end form 22 in front of the bead 24. The plunger 52 also includes a radially extending portion 57 which is sized similarly to the opening of the bushing 48 for guiding movement of the plunger 52 within the bushing 48.

The plunger 52 also presents a second spring seat 53 facing the first spring seat 50 of the bushing 48, which was discussed above. A spring 54 is disposed in the second section 42 of the bore 32 and extends between the first spring seat 50 of the bushing 48 and the second spring seat 53 of the plunger 52 for biasing the plunger 52 in a first axial direction toward the inlet orifice 34 and into a resting position, which is shown in FIG. 1 and discussed in further detail below. The spring 54 of the exemplary embodiment is a wave spring 54 formed of stainless steel stock material, though it should be appreciated that any other type of compression spring 54 could alternately be used. The exemplary plunger 52 is of a thermoplastic material and is produced through an injection molding process. However, the plunger 52 could be of any other material and may be produced using any desirable forming method.

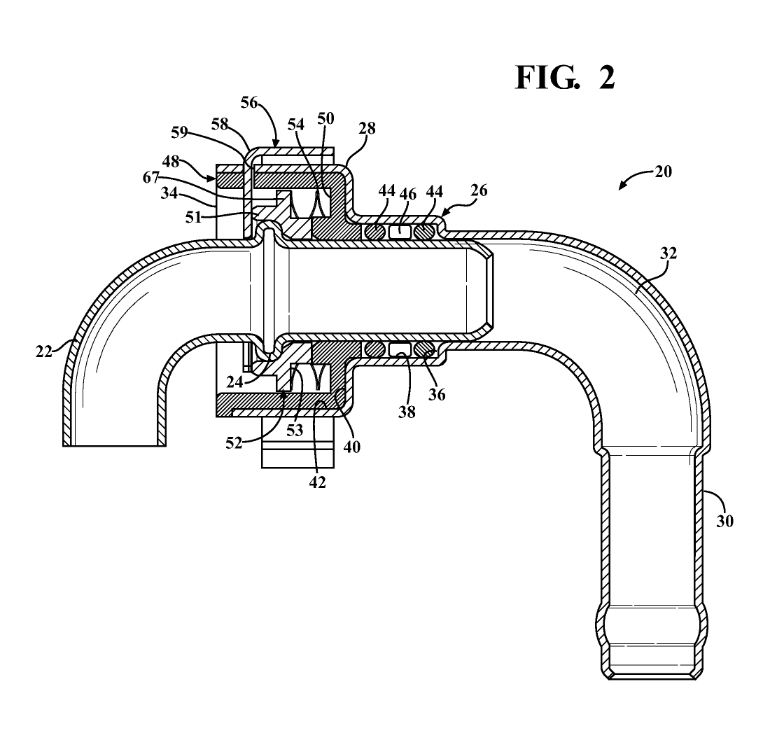

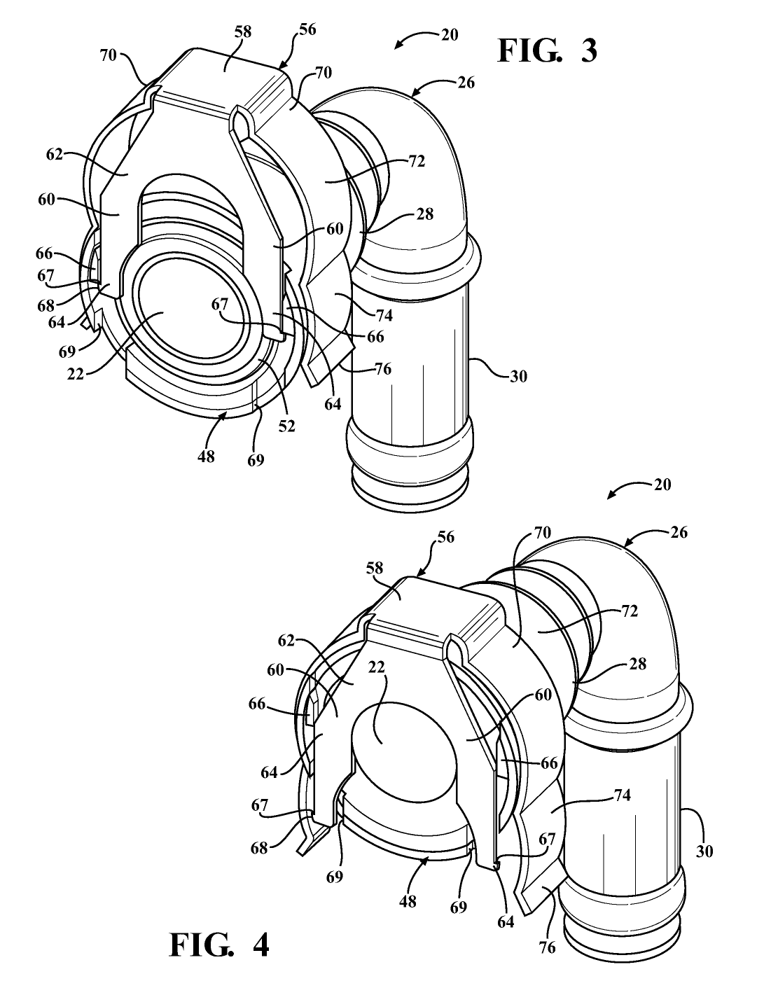

The quick connector assembly 20 also includes a locker 56 that is movable between an engaged position (FIGS. 2 and 4) for retaining the male end form 22 in the housing 26 and a non-engaged position (FIGS. 1 and 3) for allowing the male end form 22 to be inserted or withdrawn from the housing 26. The locker 56 includes a base 58 and a pair of inside legs 60 extending downwardly into the bore 32 through at least one upper gap 59 in the female receiving portion 28 of the housing 26 and the bushing 48. Each of the inside legs 60 has an upper section 62 and a different lower section 64. The upper sections 62 are spaced from one another by a distance that is slightly greater than the diameter of the male end form 22, and the lower sections 64 are spaced by a distance that is greater than the diameter of the bead 24 of the male end form 22 but less than the diameter of the plunger 52. Thus, when the locker 56 is in the non-engaged position of FIGS. 1 and 3, the spring 54 biases the plunger 52 against the lower sections 64 of the inside legs 60, and this position is hereinafter referred to as a “resting position”. Because of the larger spacing between the lower sections 64 of the inside legs 60, when the locker 56 is in the non-engaged position, the male end form 22, including the bead 24, may be inserted into the housing 26 past the inside legs 60 of the locker 56 to the location shown in FIGS. 2 and 4. Once the bead 24 clears the inside legs 60, then the locker 56 can be moved downwardly into the engaged position, which is shown in FIGS. 2 and 4. With the locker 56 in the engaged position, the bead 24 of the male end form 22 is trapped between the upper sections 62 of the inside legs 60 and the radially extending portion 57 of the plunger 52. With that, the male end form 22 has successfully been locked and sealed with the quick connector assembly 20. Additionally, the plunger 52 is biased against the bead 24 of the male end form 22, and therefore, movement of the male end form 22 relative to the housing 26 is restricted, even if the quick connector assembly 20 is vibrated, such as when a vehicle is travelling down a bumpy road. The bushing 48 may also have a flange 61 extending toward the plunger 52 for contacting the plunger 52 when the male end form 22 is locked in the quick connector assembly 20.

The bushing 48 further includes a pair of circumferentially spaced shelves 66, and each of the inside legs 60 of the locker 56 present an outwardly extending lip 67 corresponding with one of the shelves 66 and a tapered section 68 leading to the lip 67. When the locker 56 is initially installed onto the housing 26, the tapered sections 68 of the inside legs 60 engage the bushing 48 to flex the inside legs 60 inwardly. Once the lips 67 clear the shelves 66, then the inside legs 60 flex back outwardly to their unstressed positions. If a user attempts to remove an already installed locker 56 from the housing 26, the lips 67 on the inside legs 60 will engage the shelves 66 of the bushing 48 to prevent the locker 56 from being removed from the housing 26. Preferably, the lip 67 and shelves 66 are strong enough to withstand a force of up to ninety (90) Newtons.

When the locker 56 is in the engaged position, the lower sections 64 of the inside legs 60 extend downwardly through lower gaps 69 in the bushing 48 and the housing 26 to provide evidence that the locker 56 is in the engaged position. This is advantageous because it provides a visual cue to a person that the locker 56 has reached the engaged position and the male end form 22 is properly locked and sealed with the quick connector assembly 20.

The locker 56 also includes a pair of outside legs 70 extending downwardly from the base 58 for engaging the exterior surface of the female receiving portion 28 of the housing 26. The outside legs 70 are spaced from one another and each has a first arc-shaped section 72 having the same curvature as the exterior surface of the housing 26, a second arc-shaped section 74 also having the same curvature as the exterior surface of the housing 26 and a flared section 76 flaring outwardly from the second arc-shaped section 74. When the locker 56 is installed onto the female receiving portion 28 of the housing 26 during assembly of the quick connector assembly 20, the flared sections 76 of the outside legs 70 help guide the outside legs 70 onto the housing 26. The locker 56 is then pushed downwardly to flex the outside legs 70 outwardly until the second arc-shaped sections 74 engage the housing 26. At this point, the locker 56 is in the non-engaged position shown in FIGS. 1 and 3. To move the locker 56 downwardly into the engaged position shown in FIGS. 2 and 4, a downward force must be applied to the base 58 to flex the outside legs 70 outwardly until the first arc-shaped sections 72 engage the housing 26. The shape of the outside legs 70 only allows the locker 56 to remain in either the non-engaged position or the engaged position, and thus, the locker 56 of the exemplary embodiment cannot be moved into a partially-engaged position. This is yet another important safety feature of the quick connector assembly 20.

As best shown in FIG. 4, when the locker 56 of the exemplary embodiment is in the engaged position, the base 58 is raised relative to the housing 26, and the inside legs 60 extend downwardly from either side of the base 58. This arrangement presents an opening between the base 58 and the housing 26 for receiving a regular screw-driver, or a similar tool, which can be inserted into this opening and used to pry the locker 56 upwardly to the non-engaged position. Alternatively, the flared sections 76 of the outside legs 70 of the locker 56 could be pulled outwardly and upwardly to move the locker 56 from the engaged position to the non-engaged position. Thus, only a deliberate action by the user can move the locker 56 into the non-engaged position. This is still another safety feature of the quick connector assembly 20.

In the drawings of the exemplary embodiment, the stem portion 30 extends at a right angle and is shaped for mating with a hose (not shown). However, it should be appreciated that the stem portion 30 could take many different forms for mating with a wide variety of tubes and hoses depending on the desired application.

In operation, the quick connector assembly 20 starts with the locker 56 in the non-engaged position and the plunger 52 in the resting position. As discussed above, in this position, the plunger 52 is biased forwardly by the wave spring 54 against the lower sections 64 of the inside legs 60 of the locker 56. This contact between the inside legs 60 and the plunger 52 prevents the locker 56 from moving downwardly to the engaged position and prevents the plunger 52 from escaping the housing 26. The male end form 22 is then urged in an axial direction into the bore 32 of the housing 26 through the receiving inlet 34, and the front of the male end form 22 is sealed to the housing 26 through the sealing rings 44 to prevent fluid from escaping the quick connector assembly 20. Once the male end form 22 has been inserted far enough into the bore 32, the bead 24 of the male end form 22 will engage the plunger 52. Further insertion of the male end form 22 will overcome the biasing force from the wave spring 54 to move the plunger 52 backwardly. Once the bead 24 clears the inside legs 60, the locker 56 can be urged downwardly into the engaged position to trap the bead 24 of the male end form 22 between the plunger 52 and the upper sections 62 of the inside legs 60 of the locker 56. It should be noted that it is only after the male end form 22 has been inserted sufficiently far into the bore 32 of the housing 26 for the bead 24 to clear the inside legs 60 that the locker 56 can be moved into the engaged position. This feature, when combined with the visible cue that the locker 56 has been successfully moved into the engaged position ensures that the male end form 22 can only be properly locked and sealed with the quick connector assembly 20.

To remove the male end form 22 from the quick connector assembly 20, a person can either use a regular screwdriver to pry the base 58 of the locker 56 upwardly or the person can push the outside legs 70 of the locker 56 outwardly and urge the locker 56 upwardly. Once the locker 56 reaches the non-engaged position, the wave spring 54 and plunger 52 automatically ejects the male end form 22 from the bore 32 of the housing 26. Because of the lips 67 of the inside legs 60 and the shelves 66 of the bushing 48, the locker 56 cannot be completely removed from the housing 26.

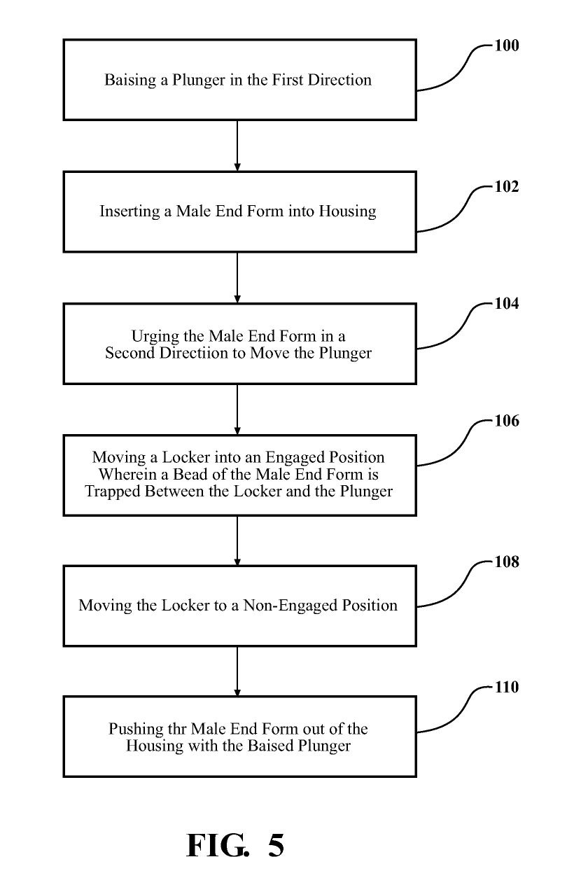

Referring now to the flow chart of FIG. 5 and the structure shown in FIGS. 1-4 and discussed above, another aspect of the present invention provides for a method of connecting a male end form 22 having a bead 24 to a quick connector assembly 20. The method includes the step 100 of biasing a plunger 52 in a first direction to a resting position where the plunger 52 restricts a locker 56 to a non-engaged position. The method proceeds with the step 102 of inserting the male end form 22 into a housing 26 of the quick connector assembly 20 so that the bead 24 of the male end form 22 contacts the plunger 52. The method then continues with the step 104 of urging the male end form 22 in a second direction opposite of the first direction to move the plunger 52 out of the resting position and free of the locker 56. The method then proceeds with the step 106 of moving the locker 56 from the non-engaged position to an engaged position wherein the bead 24 of the male end form 22 is trapped between the plunger 52 and the locker 56. The method may also include the step 108 of moving the locker 56 back into the non-engaged position and the step 110 of pushing the male end form 22 out of the housing 26 with the biased plunger 52.

Obviously, many modifications and variations of the present invention are possible in light of the above teachings and may be practiced otherwise than as specifically described while within the scope of the appended claims.

1. A quick connector assembly for establishing fluid communication between a male end form and a tube comprising:
a housing having a female receiving portion and a stem portion;
said housing presenting a bore configured to convey a fluid;
a plunger slidably disposed in said bore of said housing;
a spring disposed in said bore of said housing and engaging said plunger for biasing said plunger in a first direction toward a resting position; and
a locker movable from a non-engaged position to an engaged position only in response to a male end form being inserted into said bore of said housing and sliding said plunger away from said resting position.

2. The quick connector assembly as set forth in claim 1 wherein said locker includes a pair of inner legs each having an upper section and a lower section.

3. The quick connector assembly as set forth in claim 2 wherein the male end form includes a bead and said upper sections of said inside legs are spaced from one another by a distance which is greater than the diameter of the male end form and less than a diameter of the bead for trapping the male end form in said housing when said locker is in said engaged position.

4. The quick connector assembly as set forth in claim 3 wherein said lower sections of said inside legs are spaced from one another by a distance which is greater than the diameter of the bead of the male end form for allowing the bead to pass between the lower sections when said locker is in said non-engaged position.

5. The quick connector assembly as set forth in claim 4 wherein said housing includes at least one upper gap and wherein said inside legs of said locker extend through said at least one upper gap.

6. The quick connector assembly as set forth in claim 5 further comprising a bushing disposed in said housing and wherein said bushing includes at least one shelf and wherein each of said inside legs includes at least one lip for cooperating with said shelves to prevent said locker from being removed from said housing.

7. The quick connector assembly as set forth in claim 5 wherein said housing includes a pair of lower gaps and wherein said inside legs extend through said lower gaps and out of said housing when said locker is in said engaged position.

8. The quick connector assembly as set forth in claim 1 wherein said spring is a wave spring.

9. The quick connector assembly as set forth in claim 1 further comprising a bushing disposed in said housing and presenting a first spring seat and wherein said plunger presents a second spring seat and wherein said spring extends between said first and second spring seats to bias said plunger in said resting position.

10. The quick connector assembly as set forth in claim 1 wherein said housing further includes a stem portion.

11. The quick connector assembly as set forth in claim 1 wherein said housing includes a first section including at least one seal for establishing a sealing relationship with the male end form and a larger second section containing said plunger and said spring.

12. The quick connector assembly as set forth in claim 1 wherein the locker includes a pair of outside legs for engaging the exterior of said housing and for guiding said locker between said engaged and non-engaged positions.

13. The quick connector assembly as set forth in claim 12 wherein outside legs have a first arc-shaped section having the same curvature as the exterior surface of said housing and a second arc-shaped section having the same curvature as the exterior surface of said housing.

14. A method of establishing fluid communication between a male end form having a bead and a quick connector assembly, comprising the steps of:
biasing a plunger in a first direction to a resting position where the plunger restricts a locker to a non-engaged position;
inserting the male end form into a housing of the quick connector assembly so that the bead of the male end form contacts the plunger;
urging the male end form in a second direction opposite of the first direction to move the plunger out of the resting position and free of the locker; and
moving the locker from the non-engaged position to an engaged position wherein the bead of the male end form is trapped between the plunger and the locker.

15. The method as set forth in claim 14 further comprising the steps of moving the locker back from the engaged position to the non-engaged position and pushing the male end form out of the housing with the biased plunger.
